(19) United States
(12) Patent Application Publication
(10) Pub. No.: US 2003/0196874 A1
(43) Pub. Date: Oct. 23, 2003

(54) Conveyor belt system

(76) Inventor: Don Lunghi, Hillsborough, CA (US)

Correspondence Address: DERGOSITS & NOAH LLP, Suite 1450, Four Embarcadero Center, San Francisco, CA, 94111, US

(21) Appl. No.: 10/124,687

(22) Filed: Apr. 19, 2002

(51) Int. Cl. B65G 25/00

(52) U.S. Cl. 198/809; 198/774.3

(57) ABSTRACT

A conveyor system which allows objects to be placed on stationary surfaces at one end of a conveyor belt system prior to moving the objects. The conveyor belt system has conveyor belts mounted on pulleys having eccentric axis of rotations. The conveyor belts are mounted between two stationary surfaces that define a plane such that when the eccentric axis pulleys rotate the upper surface of the conveyor belts cyclically rise above and drop below the plane of the stationary surfaces. Objects placed on the stationary surfaces are lifted from the stationary surfaces and are moved by the rotating conveyor belt.

### FIELD OF INVENTION

The present invention describes a conveyor system used to transport objects.

### BACKGROUND OF THE INVENTION

A wide variety of powered conveyor systems have been developed for transporting objects. Referring to FIG. 1, prior art conveyor systems typically include a conveyor belt 101, pulleys 103 and a drive mechanism 105. The conveyor belt 101 is mounted tautly around pulleys 103 and a drive mechanism 105 rotates at least one of the pulleys 103 causing the conveyor belt 101 to rotate around the pulleys 103. Objects 107 placed on the moving conveyor belt 101 are transported to the other end of the belt 101 and removed from the conveyor system.

In some applications it is desirable to have a system which allows a group of objects to be placed on one end of the conveyor belt system before the group of objects is transported. U.S. Pat. No. 4,878,578 describes a conveyor belt system having a moving conveyor belt positioned between two stationary surfaces. The relative elevation of the conveyor belt and the stationary surfaces is controllable. When the conveyor belt is lower than the stationary surfaces, objects may accumulate upon the stationary surfaces and when the moving conveyor belt is elevated the objects are lifted and transported by the conveyor belt. The elevation of the conveyor belt is controlled by the operator with a complex “split cam” mechanism having special cams, rods and magnets. The belt slides rather than rolls over non-rotating cams which causes drag friction between the belt and cam.

### SUMMARY OF THE INVENTION

The present invention is a simple conveyor belt system which allows objects to placed on stationary surfaces at one end of the conveyor belt system prior to transporting the objects as a group. The inventive conveyor system comprises a conveyor belt or belts rotating about pulleys having eccentric axis of rotations. The upper surface of the conveyor belt defines a plane. The pulleys are identical and aligned so that they rotate in the synchronicity. On either side of the pulley are stationary surfaces which define a stationary plane. When the pulleys rotate, the conveyor belt moves vertically (perpendicular) relative to the stationary plane in such a way that the conveyor belt plane cycles between being above the stationary plane and being below the stationary plane.

The inventive conveyor belt is used to transport items. When the conveyor belt is below the plane of the stationary surfaces, items placed on the conveyor system rest upon the stationary surfaces. Because the items are not moving, several items may be stacked on top of each other before the conveyor belt moves the items. When the pulley plane rises above the stationary plane, the object or stacked objects are lifted off the stationary surfaces and are transported to the opposite end of the conveyor belt system before the upper surface of the conveyor belt moves below the stationary surface plane. When the conveyor belt plane drops below the stationary surface plane, more objects can be placed on the stationary surfaces.

In an embodiment, several thin conveyor belts may be mounted between several stationary planar surfaces. In this embodiment, the stationary and moving surfaces are evenly distributed so that the contact surfaces supporting the items distributed across a larger area. In another embodiment, support bars are mounted on the conveyor belt(s). The support pegs may prevent the stacked items from toppling as the conveyor belt lifts the items from the stationary surfaces. As the conveyor belts begins to lift the items from the stationary plane, the support pegs may also engage the items to prevent them from toppling. In this embodiment, the movement of the support pegs must be synchronized with the pulley plane rising above the stationary plane.

### BRIEF DESCRIPTION OF THE DRAWINGS

The invention is herein described, by way of example only, with reference to embodiments of the present invention illustrated in the accompanying drawings, wherein:

FIG. 1 is a simple conveyor system (prior art);

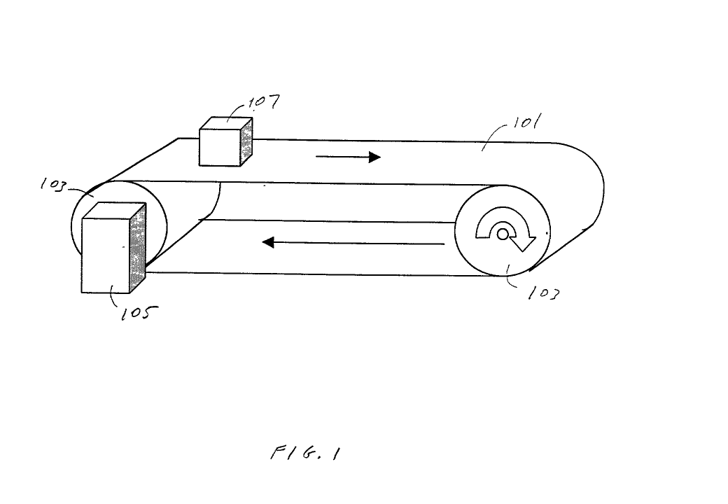

FIG. 2 is a side view of a conveyor belt system with eccentric pulleys;

FIG. 3 is a side view of a conveyor belt system with eccentric pulleys;

FIG. 4 is a top view of a conveyor belt system with eccentric pulleys; and

FIG. 5 is a side view of a conveyor belt system with eccentric pulleys and pegs mounted on the conveyor belts.

### DETAILED DESCRIPTION

The present invention addresses the above and other problems associated with variable elevation conveyor belt systems. The present invention is a simple conveyor system which allows objects to accumulate on stationary surfaces at one end of the conveyor system prior to transporting the group objects with the conveyor belt.

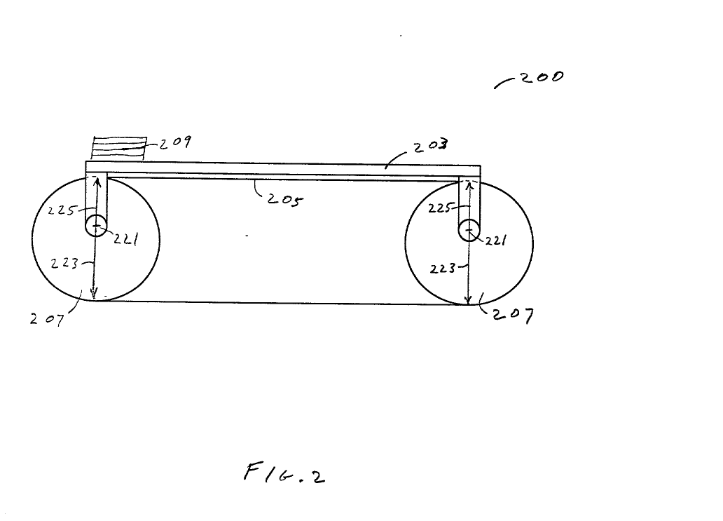

Referring to FIG. 2, an embodiment of the inventive conveyor system 200 is illustrated. For simplicity only a single conveyor belt 205 mounted on two pulleys 207 are illustrated. The inventive system typically has several conveyor belts 205 rotating in parallel each mounted on a set of pulleys 207. The inventive conveyor system 200 includes stationary surfaces 203 having a common plane mounted on either side of the conveyor belt 205. The conveyor belt 205 rotate about two pulleys 207 which have an eccentric axis of rotation 221 with a maximum radius 223 and a minimum radius 225. The pulleys 207 rotate synchronously so that portions of the upper surface of the conveyor belt 205 defines a plane substantially parallel to the stationary surfaces 203. The pulleys 207 are configured so that the upper surfaces of the conveyor belts 205 cyclically moves between positions above and below the plane of the stationary surfaces 203. Thus, when the upper surface of the conveyor belt 205 is below the stationary surfaces 203, items 209 placed on the conveyor system 200 can rest on the stationary surfaces 203. All items 209 to be transported are placed on the stationary surfaces 203 before the conveyor belt 205 rises above the stationary surfaces 203.

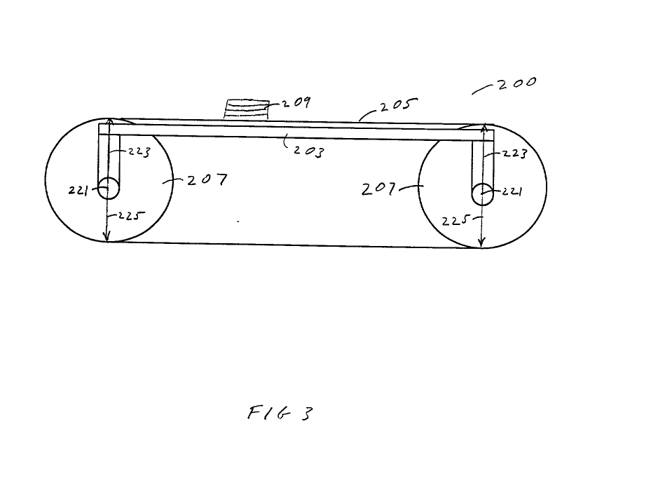

Referring to FIG. 3, as pulleys 207 rotate the maximum radius 223 rises above the axis of rotation 221 and the upper surface of the conveyor belt 205 rises above the plane of the stationary surfaces 203. The items 209 are lifted off of the stationary surfaces 203 and transported by the moving conveyor belt 205 to the other end of the conveyor system before the upper plane of the conveyor belt 205 falls below the plane of the stationary surfaces 203. When the items 209 are moved to the opposite end of the conveyor system they are removed from the conveyor belt 205.

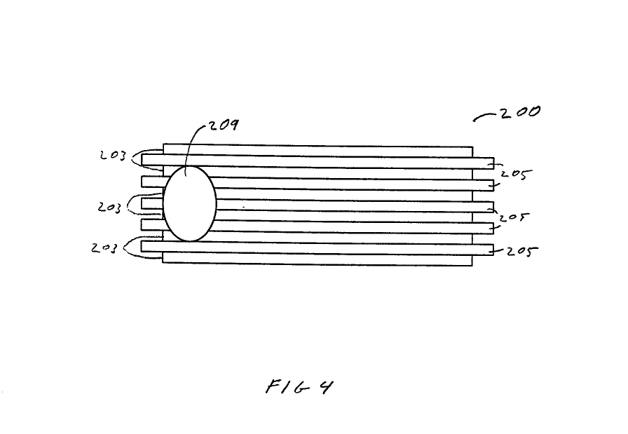

Referring to FIG. 4, a top view of the inventive conveyor belt system is illustrated having several conveyor belts 205 mounted in parallel between several stationary surfaces 203. As discussed, the stationary surfaces 203 are in a stationary plane and the upper surfaces of the conveyor belts 205 form a plane that cyclically moves above and below the plane of the stationary surfaces 203. Items 209 placed on the conveyor belt system 200 are supported by the stationary surfaces 203 when the upper surfaces of the conveyor belts 205 are lower than the stationary surfaces 203. When the conveyor belt 205 rises above the stationary surfaces 203, the items 209 are lifted and transported. The multiple parallel stationary surfaces 203 and conveyor belts 205 provide even support below the items 209 placed on the conveyor belt system 200.

In some applications, the accumulation of items involves stacking items on top of each other prior to transporting the stacked group of items. These stacked items may include slices of food products, paper products, shingles or other planar products which are stacked on top of each other prior to being transported as a group by the conveyor belt system. The inventive conveyor belt system allows individual items to be stacked on top of each other on the stationary surfaces before being transported. A potential problem with transporting stacked items is that there is a tendency for the stacked items to topple when the moving conveyor belt contacts the bottom of the stack.

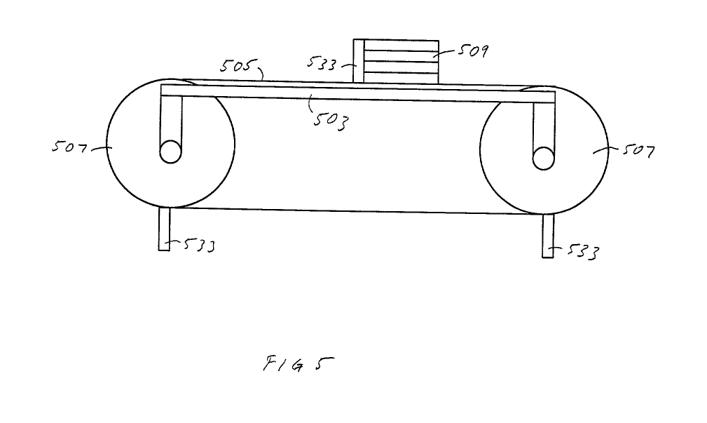

In order to prevent the toppling of the stacked items, pegs may be used to horizontally support the stacked items. Referring to FIG. 5, in an embodiment of the present invention, pegs 533 are mounted on the conveyor belts 505 to horizontally support the stacked items 509 from toppling over when transported by the conveyor belt 505. The pegs 533 are positioned on the conveyor belts 505 so that the pegs 533 arrive at the upper surface of the conveyor belts 505 as the stacked items 509 are lifted off of the stationary surfaces 503. The pegs 533 prevent the stacked items 509 from toppling when contacted by the moving conveyor belt 505.

In order for the pegs 533 to be synchronized with the vertical movement of the conveyor belt 505 the circumference of the conveyor belt 505 must be a multiple of the circumference of the pulleys 507. This geometric relationship is required for the pegs 533 to be consistently and accurately positioned as the conveyor belt 505 plane rises above the stationary surface 503 plane. To maintain the synchronization of the conveyor belt 505, pulleys 507 and the pegs 533, the inner surface of the conveyor belt 505 may be ribbed and the pulleys 507 may be splined to engage each other. In an embodiment, the inner length of the pulleys 507 is a multiple of the diameter of the pulleys 507. This configuration allows the pegs 533 to be synchronized with the vertical movement of the conveyor belt 505 so that the pegs 533 always engage the stacked items as the upper surface of the conveyor belt 505 rises above the stationary surfaces 503.

In the preferred embodiment, the conveyor belt is made of a urethane reinforced with a polyester cord. Other suitable conveyor belt materials include: rubbers, plastics and other flexible materials. Alternative reinforcement materials for the conveyor belt may be metal or fibrous materials including: polyester, nylon, kevlar, carbon or any other suitable material.

In alternate embodiments of the present invention, the pulleys about which the conveyor belts rotate may not have the same eccentric axis of rotation. For example, the conveyor belt system may be configured with the conveyor belts rotating about an eccentric axis first pulley and a concentric axis second pulley. In this configuration, the stationary surfaces may only be positioned around the first eccentric axis pulleys. Items are allowed to accumulate on the stationary surfaces close to the first eccentric axis pulleys when the conveyor belt is below the stationary surfaces. The items are then lifted off of the stationary surfaces by the upward movement of the conveyor belt and transported towards the concentric pulley end of the conveyor belt.

In the foregoing, a conveyor belt system has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A conveyor system for transporting objects comprising:
a first pulley having an eccentric axis of rotation;
a second pulley;
a conveyor belt having an upper surface mounted on the first pulley and the second pulley; and
two stationary surfaces mounted on opposite sides of the length of the conveyor belt;
wherein when the first pulley rotates the upper surface of the conveyor belt cyclically rises above and falls below the two stationary surfaces.

2. The conveyor system of claim 1, wherein the second pulley has an eccentric axis of rotation and the rotations of the first pulley and the second pulley are synchronized.

3. The conveyor system of claim 1, wherein the second pulley has a concentric axis of rotation.

4. The conveyor system of claim 1, wherein the first pulley has a splined circumference and the inner surface of the conveyor belt has ribs running across the width of the conveyor belt.

5. The conveyor system of claim 1, wherein a plurality of pegs are mounted on an outer surface of the conveyor belt and the pegs are substantially perpendicular to the outer surface of the conveyor belt.

6. The conveyor system of claim 5, wherein the first pulley has a splined circumference and an inner surface of the conveyor belt has ribs running across the width of the conveyor belt which engage the splines of the first pulley and the number of ribs on inner surface of the conveyor belt is a multiple of the number of splines on the circumferences of the first pulley.

7. The conveyor system of claim 1, wherein a plurality of posts are mounted on an outer surface of the conveyor belt at multiple points which are symmetric along the length of the conveyor belt.

8. A conveyor system for transporting objects comprising:
a first axle having a first pulleys and a second pulley, wherein the first pulley and the second pulley have eccentric axis of rotations;
a second axle mounted in parallel with first axle having a third pulley and a fourth pulley;
a first conveyor belt mounted on the first pulley and the third pulley;
a second conveyor belt mounted on the second pulley and the fourth pulley, wherein the second conveyor belt is mounted in parallel to the first conveyor belt;
a plurality of elongated stationary surfaces defining a stationary plane mounted between the conveyor belts and adjacent to the length of the second conveyor belts;
wherein when the first axle rotates the first pulley and the third pulley the upper surface of the first conveyor belt and the upper surface of the second conveyor belt cyclically rise above and fall below the two stationary surfaces.

9. The conveyor system of claim 8, wherein the first pulley and the second pulley are aligned on the first axle.

10. The conveyor system of claim 8, wherein the third pulley and the fourth pulley has an eccentric axis of rotation.

11. The conveyor system of claim 8, wherein the rotations of the first pulley and the second pulley are aligned and rotate in synchronization.

12. The conveyor system of claim 8, wherein the first and second pulleys have splined circumferences and the inner surfaces of the first conveyor belt and the second conveyor have ribs running across the width of the conveyor belt.

13. The conveyor system of claim 8, wherein a plurality of pegs are mounted on an outer surface of the first conveyor belt and the pegs are substantially perpendicular to the outer surface of the first conveyor belt.

14. The conveyor system of claim 13, wherein the first and second pluralities of pulleys have splined circumferences, the inner surface of the conveyor belt has ribs running across the width of the conveyor belt and the number of ribs on inner surface of the conveyor belt is a multiple of the number of splines on the circumferences of the first pulley.

15. A method of transporting an object comprising the steps of:
providing a conveyor belt system having: a conveyor belt mounted on a first pulley having an eccentric axis of rotation and a second pulley and stationary surfaces mounted on opposite sides of the length of an upper surface of the conveyor belt defining a stationary plane,
rotating the first pulley to move the conveyor belt;
placing the object on the stationary surfaces;
lifting the object off of the plurality of stationary surfaces with the conveyor belt; and
transporting the object towards the second pulley.

16. The method for transporting the object of claim 15, wherein the second pulley has an eccentric axis of rotation.

17. The method for transporting the object of claim 15 further comprising the step of:
stacking objects on top of the object placed on the stationary surfaces;
wherein a plurality of pegs are mounted on an outer surface of the first conveyor belt substantially perpendicular to the outer surface of the first conveyor belt and the pegs prevent the stacked objects from toppling during the transporting step.

18. The method for transporting the object of claim 15 further comprising the step:
removing the object from the conveyor belt.

19. The method for transporting the object of claim 15, wherein the first pulley has a splined circumference and the conveyor belt has a ribbed inner surface which engage the splines of the first pulley during the rotating step.

20. The method for transporting an object as in claim 19, wherein the second pulley has an excentric axis of rotation and a splined circumference which engages ribbed inner surface of the conveyor belt and the rotating the first pulley step causes the second pulley to rotate.
